(19) United States
(12) Patent Application Publication
(10) Pub. No.: US 2009/0181356 A1
(43) Pub. Date: Jul. 16, 2009

(54) INTERACTIVE LEARNING

(75) Inventor: Mousumi Dasgupta, Irving, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES INC., Temple Terrace, FL (US)

(21) Appl. No.: 12/013,793

(22) Filed: Jan. 14, 2008

(51) Int. Cl. G09B 7/00

(52) U.S. Cl. 434/362

(57) ABSTRACT

A method may include identifying, by a computer, test scores stored in a database and associated with a student; selecting, by a computer, a quiz from a group of quizzes based on the identified test scores; sending the quiz through a network to the student; receiving, through the network, a completed quiz from the student; scoring, by the computer, the completed quiz and recording the score in the database; and adding points to an account associated with the student, the number of points based on the score of the completed quiz.

### BACKGROUND INFORMATION

On average, students in the United States spend four hours each day watching television. Even if students were to watch educational television during this time, which they probably would not, the students would still be passively watching—not the ideal educational setting.

### BRIEF DESCRIPTION OF THE DRAWINGS

FIG. 1 shows an exemplary environment in which embodiments described herein may be implemented;

FIG. 2 is a block diagram of exemplary components of a computing module;

FIG. 3 is a block diagram of an exemplary document table;

FIG. 4 is a block diagram of an exemplary user table;

FIG. 5 is a block diagram of an exemplary student achievement table;

FIG. 6 is a block diagram of an exemplary profile access table;

FIG. 7 is a diagram of a remote control;

FIG. 8 is a flowchart of an exemplary process for creating course profiles and assignments;

FIG. 9 is a flowchart of an exemplary process for testing students;

FIG. 10 is a block diagram of a graphical user interface for displaying an exemplary quiz question;

FIG. 11 is a block diagram of an exemplary environment for an interactive quiz show;

FIG. 12 is a flowchart of an exemplary process for an interactive quiz game show;

FIG. 13 is a block diagram of an exemplary graphical user interface for displaying an interactive quiz show;

FIG. 14 is a block diagram of an exemplary graphical user interface for displaying an exemplary menu selection;

FIG. 15 is a block diagram of an exemplary graphical user interface for displaying an exemplary student profile;

FIG. 16 is a block diagram of an exemplary graphical user interface for displaying an exemplary menu selection for an interactive live class;

FIG. 17 is a block diagram of an exemplary graphical user interface for displaying an interactive live class; and

FIG. 18 is a block diagram of an alternative exemplary environment in which systems and methods described herein may be implemented.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Interactive learning may be a better learning environment for students as compared to passive television viewing. In one or more embodiments described herein, students may communicate and collaborate with their teachers, peers, and parents in a learning environment.

One or more embodiments disclosed herein may allow for management of the learning work flow; assessment of student achievement; ad hoc communication and collaboration among educators, students, and parents; and sharing and management of educational content.

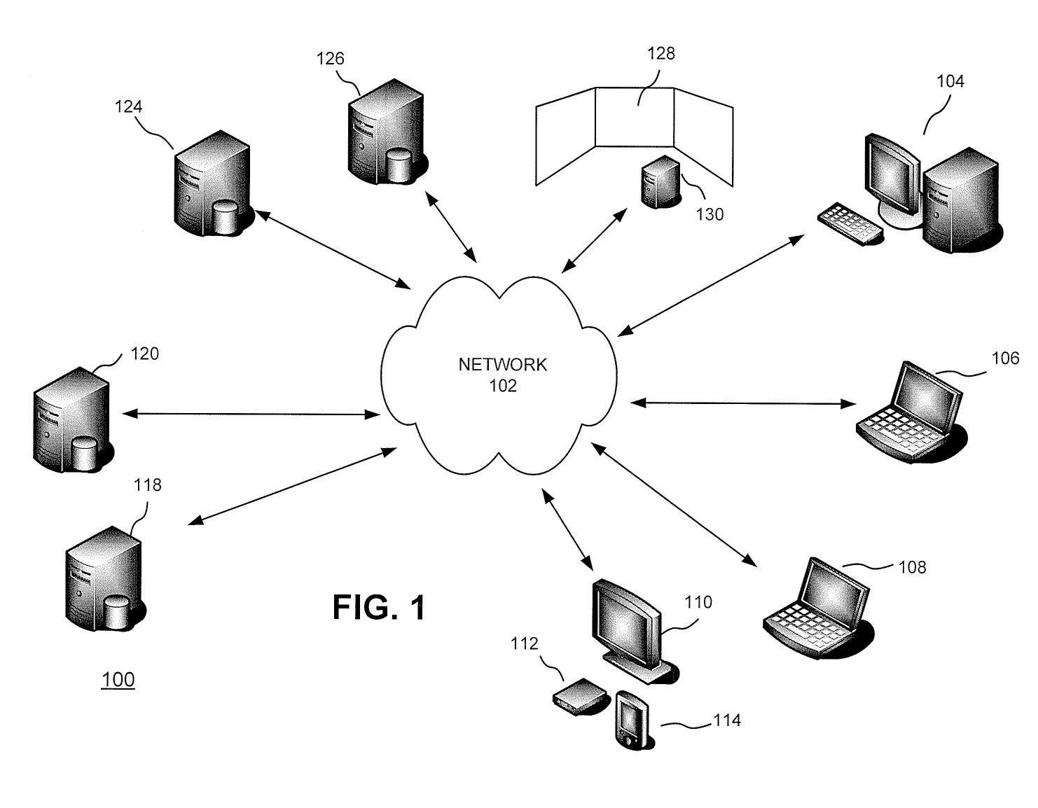

FIG. 1 shows an exemplary interactive educational environment 100 (environment 100 or interactive environment 100) in which embodiments described herein may be implemented. As shown, environment 100 may include a network 102 communicating with a group of devices 104-130. These devices may include, among other things, a classroom computer 104, a student computer 106, a parent computer 108, a television 110 (TV 110), a set-top-box 112 (STB 112), a remote control 114 (remote 114), a course curriculum, course profile, and assignment database 118, an application and web server 120, a student profile database 124, a materials database 126, a studio 128, and a studio server 130.

In other embodiments, environment 100 may include more, fewer, or different devices. For example, environment 100 may include printers for printing documents on paper. As another example, environment 100 may include more than one student computer, more than one parent computer, more than one classroom computer, etc. Moreover, one or more devices 104-130 may perform one or more functions of any other device of personal network 100. Furthermore, one or more of devices 104-130 may be remotely located from each other. Although FIG. 1 shows devices 104-130 coupled to network 102, devices 104-130 may also be coupled with each other and/or may be able to communicate directly with each other. For example, parent computer 120 may be directly coupled to student computer 118, without traversing network 102.

Besides the devices shown in FIG. 1, devices coupled to network 102 may include any computational device, including among other things: a camcorder, a personal computer; a telephone, such as a radio telephone; a personal communications system (PCS) terminal that may combine a cellular radiotelephone with data processing, facsimile, and/or data communications capabilities; an electronic note pad; a personal music player (PMP); a personal digital assistant (PDA) that may provide Internet/intranet access, web browser, organizer, calendar, and a global positioning system (GPS).

Network 102 may include the Internet, an ad hoc network, a local area network (LAN), a wide area network (WAN), a metropolitan area network (MAN), a cellular network, a public switched telephone network (PSTN), or any other network or combinations of networks. Network 102 may include a high-speed fiber optic network, such as Verizon's FiOS™ network. A fiber-optic network may provide for a high-speed link from network 102 to devices coupled to network 102, e.g., STB 112, and a high-speed link from devices coupled to network 102, e.g., STB 112, to network 102. In one embodiment, the link from network 102 to devices coupled to network 102, e.g., STB 112, may be symmetric or near symmetric, allowing for data rates to be the same or near the same, e.g., high speed, from network 102 to devices coupled to network 102 and vice versa. Network 102 may include a video signaling and distribution network to distribute the information from a content delivery system.

Classroom computer 104 (computer 104) may include one or more computer systems for hosting programs, databases, and/or applications. Computer 104 may include a laptop or any computing device, e.g., a PDA, PMP, mobile phone, etc. Computer 104 may be located in a school classroom and may be accessible by a teacher and/or student, for example. A teacher may use computer 104, for example, to create quizzes, homework assignments, or course materials for students. The teacher may use computer 104 to download educational materials from materials database 126 for incorporation into quizzes, assignments, or course materials. The teacher may use computer 104 to send quizzes, assignments, or other course materials to students (or otherwise make them available to students, such as by posting the materials to assignment database 118 or accessible storage medium). The teacher may use computer 104 to receive completed quizzes or assignments from students. Assignments, quizzes, and other course material, for example, may include Portable Document Format (PDF) documents, word processing documents, video files, audio files, text files, etc. The teacher may use computer 104 to grade student assignments or quizzes and may access student profiles in student profile database 124. The teacher may use computer 104 to communicate with students (via email or messaging (e.g., text message and/or instant messaging)) and/or communicate with parents. Computer 104 may be used in the classroom to present course materials to students in the classroom.

Student computer 106 (computer 106) may include one or more computer systems for hosting programs, databases, and/or applications. Computer 106 may include a laptop or any computing device, e.g., a PDA, PMP, mobile phone, etc. Computer 106 may be used by a student in the student's home or in the student's classroom, for example. Computer 106 may include a media manager application program for storing, organizing, and playing digital media. For example, the media manager may stream music stored on computer 106 to TV 110. The media manager may send digital photographs stored on student computer 106 for display on TV 110 or parent computer 108. The media manager may create play lists of digital media and slide shows of photographs. The media manager may download digital media content from, for example, television broadcasts, the Internet, and/or a home network.

Computer 106 may include a browser application program for navigating the Internet and/or World-Wide Web (WWW). A student may use student computer 106 to receive assignments including PDF documents, word processing documents, video files, music files, text files, etc. A student may use computer 106 to communicate with (via email or messaging) other students, parents, and/or teachers. Computer 106 may be used to watch live classroom sessions. Computer 106 may be used to take interactive quizzes and complete assignments or participate in an online, interactive quiz show.

Parent computer 108 (computer 108) may include one or more computer systems for hosting programs, databases, and/or applications. Computer 108 may include a laptop or any computing device, e.g., a PDA, PMP, mobile phone, etc. Using computer 108, the parent may access a student's profile (e.g., a child's profile) stored in student profile database 124, discussed below. Using computer 108, the parent may email or message a student or the student's teacher. Using computer 108, the parent may request help, e.g., academic coaching, for a student in need. Using computer 108, the parent may manage a student's account, e.g., configure who can access profile information, etc. Using computer 108, the parent may view the student's curriculum, course profiles, course assignments, communications, etc. Using computer 108, the parent may view a student's progress as reported by teachers or view developmental graphs, recommended courses, or self help materials that may be downloaded and/or purchased in form of video-on-demand (VOD) content or interactive content.

TV 110 may include a liquid crystal display (LCD), a cathode ray tube (CRT), a plasma display, etc. Television 110 may be associated with one or more speakers that output audio signals, such as stereo or mono audio. Television 110 may be associated with STB 112. STB 112 may include one or more computer systems for hosting programs, databases, and/or applications. STB 112 may receive communications from a cable and/or network service provider and may output video signals for display on TV 110. STB 112 may send communications to a cable and/or network service provider, e.g., requests for content for display. STB 112 may be used to order and receive VOD content from a content provider. TV 110 may be associated with remote 114. Remote 114 may include control keys to navigate menus displayed on TV 110, for example, and to otherwise control functions of TV 110. TV 110 may perform the same functions as student computer 106 and/or parent computer 108.

Course curriculum, course profile, and assignment database 118 (database 118) may store course curricula, e.g., topics and subjects that a teacher may be required to teach. Database 118 may also store a teacher's course profile, e.g., a teacher's teaching plan including assignments with material copied from materials database 126 or referred to as being stored in materials database 126. Database 118 may also store assignments and quizzes prepared by the teacher for class.

Application and web server 120 (server 120) may include one or more computer systems for hosting programs, databases, and/or applications. Server 120 may run a web server application, such as Apache, to serve web pages when requested. Server 120 may serve pages including information from student profile database 124, materials database 126, or database 118. For example, if the parent uses a web browser in computer 108 to access a student's profile, the request may be sent to server 120, which may request the information from student profile database 124. Server 120 may then serve the information to computer 108 for viewing by the parent.

Server 120 may allow for messaging between student, teachers, and/or parents. Messaging between students, teachers, and/or parents may include “white boarding,” e.g., the interactive free-hand writing collaboration between students, teachers, and/or parents. Server 120 may allow for the viewing of live classes from a classroom or from studio 128. Server 120 may allow for other forms of collaboration between students, teachers, and parents, including Voice over Internet Protocol (VoIP) or video conferencing, for example. Server 120 may include an application to help a teacher to use classroom computer 104 to develop course profiles or quizzes. Server 120 may automatically score online quizzes taken by students. Server 120 may evaluate student performance, e.g., a student's scores, and may recommend an interactive study course to improve student performance.

Student profile database 124 may store profiles associated with students. A student's profile may include quizzes, assignments, quiz scores, assignment scores, the identity of individuals privileged to access the profile, etc. A student's profile may include an indication of the school the student attends. A student profile may include the grade (e.g., scores) the student has achieved in each class and the number of points the student has earned for completing quizzes and assignments.

Materials database 126 may include a library of instructional resources. The instructional resources may be categorized and organized and may be searched by, for example, teachers, students, or parents. Videos across numerous topics may be stored in materials database 126 and may simplify difficult topics to increase learning retention. Materials database 126 may include recorded classes, VOD, course profiles, projects, worksheets, quizzes, glossaries, encyclopedias, dictionaries, etc. The teacher may upload course profiles, assignments, and quizzes that the teacher created to materials database 126 for sharing with other teachers.

Studio 128 may include a recording studio (including one or more microphones and/or video cameras), a stage, an amphitheater, etc. Studio 128 may be located in a school or in the offices of a major broadcasting network, for example. Studio 128 may allow for conferences, plays, game shows, television shows, etc. Studio 128 may include studio server 130 that may broadcast events taking place in studio 128.

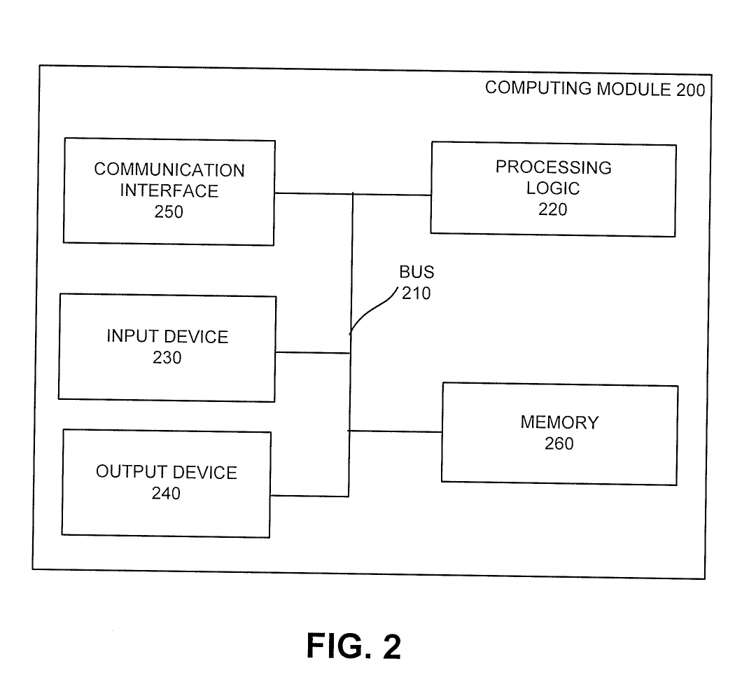

FIG. 2 is a block diagram of exemplary components of a computing module 200 (module 200). Any one of devices 104-130 may include one or more computing modules, such as computing module 200. Module 200 may include a bus 210, processing logic 220, an input device 230, an output device 240, a communication interface 250, and a memory 260. Module 200 may include other components (not shown) that aid in receiving, transmitting, and/or processing data. Moreover, other configurations of components in device 200 are possible. Further, one or more components of module 200 may be remotely located.

Bus 210 may include a path that permits communication among the components of module 200. Processing logic 220 may include any type of processor or microprocessor (or groups of processors or microprocessors) that interprets and executes instructions. In other embodiments, processing logic 220 may include an application-specific integrated circuit (ASIC), a field-programmable gate array (FPGA), or the like.

Input device 230 may include a device that permits a user to input information into module 200, such as a keyboard, a keypad, a mouse, a pen, a microphone, a remote control, a touch-screen display, one or more biometric mechanisms, or the like. Output device 240 may include a device that outputs information to the user, such as a display, a printer, a speaker, etc. Output device 240 may include a vibrator to alert a user.

Input device 230 and output device 240 may allow the user of module 200 to receive a menu of options. The menu may allow the user to select various functions or services associated with applications executed by module 200 or other devices coupled to network 102. Input device 230 and output device 240 may allow the user to activate a particular service or application, such as a service defined by a device table described below.

Communication interface 250 may include any transceiver-like mechanism that enables module 200 to communicate with other devices and/or systems. Communication interface 250 may include a transmitter that may convert baseband signals from processing logic 220 to radio frequency (RF) signals and/or a receiver that may convert RF signals to baseband signals. Alternatively, communication interface 250 may include a transceiver to perform functions of both a transmitter and a receiver. Communication interface 250 may be coupled to an antenna for transmission and reception of the RF signals. Communications interface 250 may include a network interface card, e.g., Ethernet card, for wired communications or a wireless network interface (WiFi) card for wireless communications. Communication interface 250 may also include, for example, a universal serial bus (USB) port for communications over a cable, a Bluetooth wireless interface for communicating with other Bluetooth devices, a near-field communication (NFC) device, etc. Communications interface 250 may receive, transmit and/or process digital or analog audio inputs/outputs and/or digital or analog video inputs/outputs.

Memory 260 may include a random access memory (RAM) or another type of dynamic storage device that may store information and instructions, e.g., an application, for execution by processing logic 220; a read-only memory (ROM) device or another type of static storage device that may store static information and instructions for use by processing logic 220; and/or some other type of magnetic or optical recording medium and its corresponding drive, e.g., a hard disk drive (HDD), for storing information and/or instructions.

Module 200 may perform certain operations, as described in detail below. Module 200 may perform these operations in response to processing logic 220 executing software instructions contained in a computer-readable medium, such as memory 260. A computer-readable medium may be defined as a physical or logical memory device. The software instructions may be read into memory 260 from another computer-readable medium or from another device via communication interface 250. The software instructions contained in memory 260 may cause processing logic 220 to perform processes that are described below.

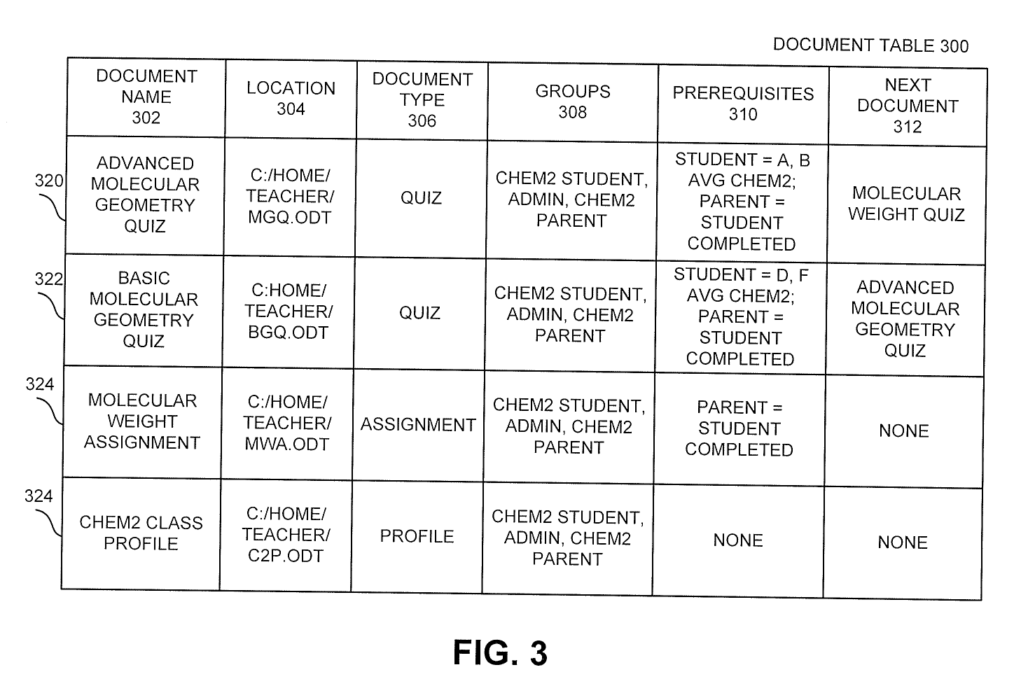

FIG. 3 is a block diagram of an exemplary document table 300. Document table 300 may keep track of all the quizzes, assignment, and course profiles stored in interactive environment 100. Document table 300 may also store or maintain characteristics of the course profiles, assignment, or quizzes, for example. Document table 300 may be stored in memory 260 of database 118, for example, or any device coupled to network 102. In another embodiment, document table 300 may be stored in memory 260 of student profile database 124 or in memory 260 of materials database 126, for example. Document table 300 may include a document name field 302, a location field 304, a document type field 306, a groups field 308, a prerequisites field 310, and a next document field 312. These fields are exemplary and document table 300 may include additional, different, or fewer fields than illustrated in FIG. 3.

Document name field 302 may include the name of the document (e.g., course profile, quiz, or assignment) created by a teacher, for example. The name may be descriptive of the document, such as ADVANCED MOLECULAR GEOMETRY QUIZ as shown in record 320 of FIG. 3. Location field 304 may include the path and filename of the document, such as “c:/home/teacher/quizzes/mgq.odt” as shown in record 320 of FIG. 3, for example.

Document type field 306 may include the type of document associated with the record, such as QUIZ, ASSIGNMENT, or COURSE PROFILE, for example. As shown in record 320, the document with the name MOECULE GEOMETRY QUIZ may have the type QUIZ shown in document type field 306. As shown in record 322, the document with the name BASIC MOECULE GEOMETRY QUIZ may also have the type QUIZ shown in document type field 306.

Groups field 308 may include the groups of people allowed to access the document. For example, the document associated with record 320 may be accessed by CHEM2 STUDENT (e.g., any student taking Chemistry 2 class), CHEM2 PARENT (e.g., any parent of a student taking Chemistry 2 class), and ADMIN (e.g., any school or district administrator). Similarly, the document associated with record 322 may also be accessed by CHEM2 STUDENT, CHEM2 PARENT, and ADMIN (e.g., the school and district administration).

Prerequisites field 310 may include the prerequisites, e.g., conditions such as an achievement level, etc., for taking or viewing the associated document. For example, the quiz associated with record 320 may only be taken or viewed by students with a B average or higher (e.g., IF STUDENT, GRADE=A or B). The quiz associated with record 320 may only be taken or viewed by a parent after the student has taken the quiz (e.g., IF PARENT, QUIZ=COMPLETED). In another example, a basic quiz may be associated with students who have a “D” science average. In exemplary document table 300, the quiz associated with record 322 (with title BASIC MOLECULTE GEOMETRY QUIZ) may only be taken or viewed by students with an F or D average (e.g., IF STUDENT, GRADE=D or F).

Next document field 312 may include one or more names of the profiles, quizzes, or assignments that a student may complete next after completing the assignment, quiz, or profile associated with the current record. For example, after completing the ADVANCED MOLECULAR GEOMETY QUIZ, the student may be referred to the MOLECULAR WEIGHT QUIZ, as indicated in record 320 of document table 300. After completing the BASIC MOLECULAR GEOMETRY QUIZ, the student may be referred to the MOLECULAR GEOMETRY QUIZ of record 320, for example, as indicated in record 322.

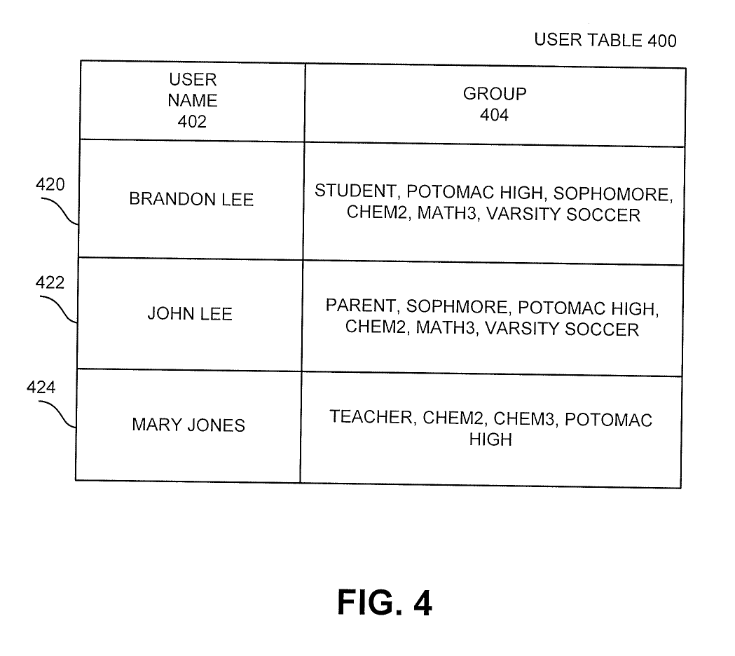

FIG. 4 is a block diagram of an exemplary user table 300. User table 300, e.g., a database, may define the users allowed to access interactive environment 100, such as databases 118, 124, and 126, and application and web server 120, for example, and the groups associated with the corresponding user. User table 400 may be stored in memory 260 of any device attached to network 102, such as database 118, 124, or 126, or web server 120. User table 400 may include a user name field 402 and a group field 404. User table 300 may include additional, different, or fewer fields than illustrated in FIG. 4.

User name field 402 may include the name of a user that may have access to interactive environment 100. Students, teachers, and parents may each have a user name and a record in user table 400. In the exemplary user table 400, there are three users listed: BRANDON LEE, JOHN LEE, and MARY JONES. In other words, Brandon Lee, John Lee, and Mary Jones maybe allowed some form of access to interactive environment 100.

Group field 404 may indicate the groups with which the corresponding user name in user name field 402 is associated. In the exemplary user table 400, record 420 indicates the user name BRANDON LEE may be associated with the following groups as indicated in the corresponding group field 404: STUDENT, POTOMAC HIGH, SOPHOMORE, CHEM2, MATH3, and VARSITY SOCCER. In other words, Brandon Lee may be a sophomore student Potomac High who takes Chemistry 2 class and Math 3 class and is on the varsity soccer team. In the exemplary user table 400, record 422 indicates a user name JOHN LEE may be associated with the following groups as indicated in the corresponding group field 404: PARENT, SOPHOMORE, POTOMAC HIGH, CHEMISTRY 2, MATH 3, and VARSITY SOCCER. In other words, John Lee is a parent of a sophomore student that attends Potomac High that takes Chemistry 2 and Math 3 and is on the varsity soccer team. Record 424 indicates the user name MARY JONES may be associated with the following groups: TEACHER, CHEMISTRY 2, and POTOMAC HIGH. In other words, Mary Jones may be a teacher at Potomac High who teaches Chemistry 2.

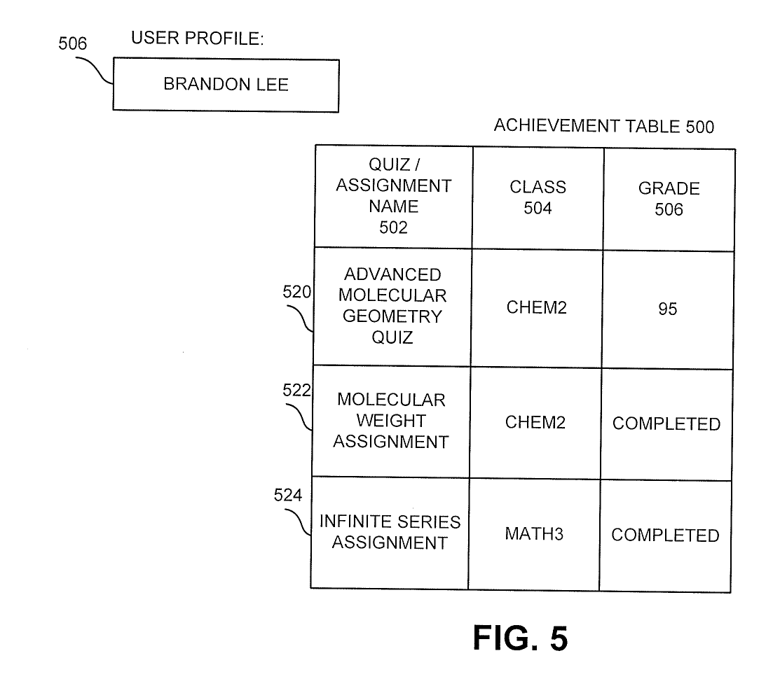

FIG. 5 is a block diagram of an exemplary student achievement table 500. Achievement table 500, e.g., a database, may store the quizzes and assignments completed by a student and the corresponding grades for the quizzes or assignments. There may be an achievement table 500 for each student in interactive environment 100 and/or for each student listed in user table 400. Student achievement table 500 may be stored in memory 260 of student profile database 124. In another embodiment, student achievement table 500 may be stored in any device attached to network 102, such as in memory 260 of web server 120 or database 118. Student achievement table 500 may include a quiz/assignment name field 502, a class field 504, a score field 506, and a student name field 508. Student achievement table 500 may include additional, different, or fewer fields than illustrated in FIG. 5.

Quiz/assignment name field 502 may include the name of the quiz or assignment taken by a student listed in student name field 508. Exemplary achievement table 500 may be for the student BRANDON LEE as indicated in student name field 508. As indicated by quiz/assignment name field 502, Brandon Lee may have taken the following quizzes and assignments: ADVANCED MOLECULAR GEOMETRY QUIZ, MOLECULAR WEIGHT ASSIGNMENT, and INFINITE SERIES ASSIGNMENT. Class field 504 may indicate the class associated with the corresponding quiz or assignment in field 502. In the exemplary achievement table 500, the ADVANCED MOLECULAR GEOMETRY QUIZ and MOLECULAR WEIGHT ASSIGNMENT are for CHEM2 and the INFINITE SERIES ASSIGNMENT was for MATH3. Score field 506 indicates the grade corresponding to the quiz or assignment in field 502. In the exemplary achievement table 500, Brandon Lee scored a 95% on the ADVANCED MOLECULAR GEOMETRY QUIZ and COMPLETED the INFINITE SERIES ASSIGNMENT.

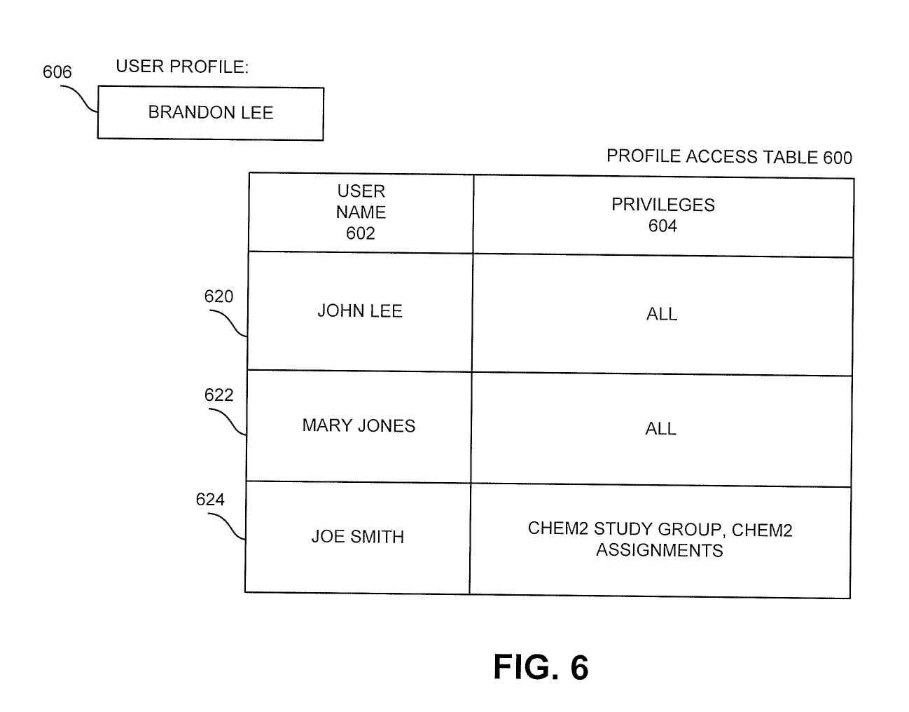

FIG. 6 is a block diagram of an exemplary profile access table 600. Profile access table 600, e.g., a database, may define the set of privileges (e.g., permissions) afforded each user name. Profile access table 600 may be stored in memory 260 of student profile database 124. In another embodiment, profile access table 600 may be stored in memory 260 of any device coupled to network 102, such as database 118 or web server 120. Profile access table 600 may include a user name field 602, a privilege field 604, and a student name field 606. Profile access table 600 may include additional, different, or fewer fields than illustrated in FIG. 6.

User name field 602 may identify one or more users that may have varying privileges to access the profile associated with the student identified in student name field 606. For example, exemplary profile access table 600 allows the following user names to have some access to Brandon Lee's profile (e.g., the profile of the student BRANDON LEE identified in student name field 606): JOHN LEE, MARY JONES, and JOE SMITH.

Privileges field 604 may include the permissions afforded the user name in the corresponding user name field 102. Such permissions may include ALL, ASSIGNMENTS, QUIZZES, etc. A permission of ALL may indicate that the user name may have full access to all the information stored in the profile identified in student name field 606. A permission of ASSIGNMENTS may indicate that the corresponding user name may have access to all the information stored in the profile related to assignments. A permission of QUIZZES may indicate that the corresponding user name may have access to all the information stored in the profile related to quizzes. Privileges other than ALL, ASSIGNMENTS, and QUIZZES are possible. The exemplary profile access table 600 may grant the user name JOHN LEE with privileges of ALL. In other words, Brandon Lee's father, John Lee, may have full access to his son's profile. Profile access table 600 may grant the user name MARY JONES with the privilege of ALL. In other words, Brandon Lee's teacher, Mary Jones, may have full access to her student's profile. Profile access table 600 may grant the user name JOE SMITH with the privilege of CHEM2 ASSIGNMENTS and CHEM2 STUDY GROUP. In other words, Brandon Lee's classmate, Joe Smith, may have access to Brandon Lee's chemistry assignments and study group material.

Privileges field 604 may also provide other limitations to permissions, such as the time of day access may be allowed. For example, a permissions field 304 including “1500-1800” may indicate permission to access profile information between the hours of 1500 and 1800. Permissions may be indicated negatively, e.g., by indicating what permissions are not allowed. For example, a permission of “NOT CHEM2” may indicate that a lack of permission to access information related to Chemistry 2 class. The privileges afforded user names may be changed, for example, by adding, removing, or editing entries in privilege table 300.

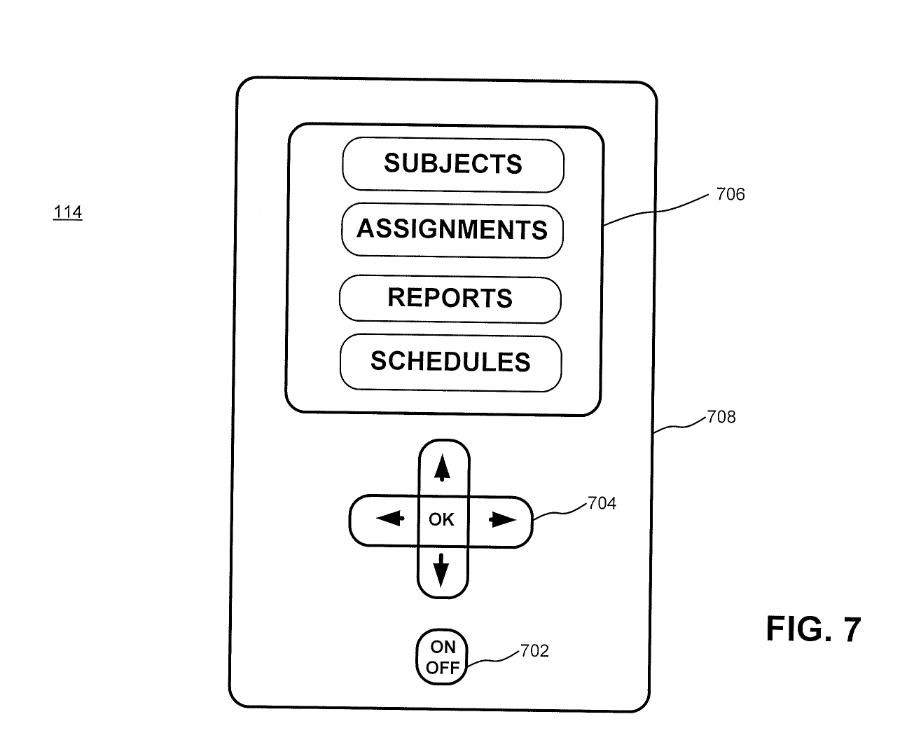

FIG. 7 is a diagram of an exemplary remote 114 of FIG. 1. Remote 114 may include an on/off button 702, control buttons 704, a display 706, and a housing 708. On/off button 702 may turn TV 110 on and off. Control buttons 704 may include left, right, up, down, and OK buttons. The user of remote 114 may interact with TV 110 to control TV 110. For example, remote control 114 may be used to navigate menus displayed on TV 110. Remote 114 may also be used to navigate menus displayed on display 706, such as navigating and selecting a SUBJECTS button, an ASSIGNMENTS button, a REPORTS button, and a SCHEDULES button. Remote control 114 may be used, for example, to input answers to quiz questions shown on TV 110 or display 706. Remote 114 may communicate with TV 110 via infra red (IR) or RF signals.

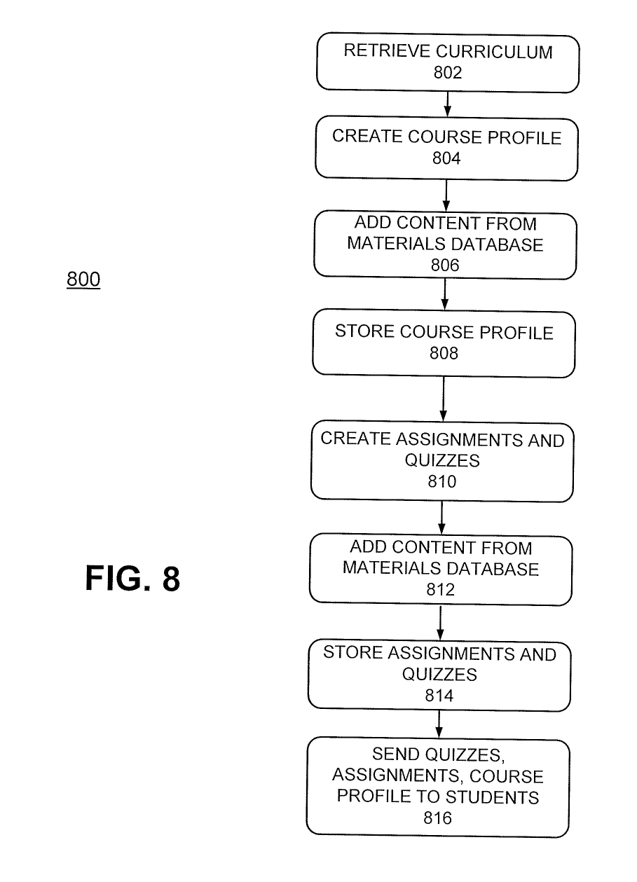

FIG. 8 is a flowchart of an exemplary process 800 for creating course profiles and assignments. A curriculum may be received (block 802). For example, a teacher may use classroom computer 104 to retrieve the curriculum from database 118. A course profile may be created (block 804). For example, using classroom computer 104, the teacher may create a course profile, e.g., a course outline, for example. Content may be added to the course profile from materials database 126 (block 806). The teacher may search and browse content from materials database 126 on computer 104, for example, to determine what material may be best for inclusion in the course profile. The course profile may be stored (block 808). The teacher may store the course profile in database 118 along with characteristics associated with the course profile (such as, e.g., the course name, etc.) in document database 300. For example, a teacher may create a profile for CHEM2 class and save it to a location of “c:/home/teacher/c2p.odt.” The teacher may indicate this location in record 326 of document table 300 where the document name is also recorded as CHEM2 CLASS PROFILE. The teacher may also allow groups CHEM2 STUDENT, ADMIN, and CHEM2 PARENT to have access to the document. In this example, the teacher may choose not to specify any prerequisites or next documents (as shown in record 326, fields 310 and 312).

An assignment or quiz may be created (block 810). For example, the teacher, using classroom computer 104, may create an assignment or quiz for students to complete at home. The teacher may also create a quiz or assignment for students to complete at home or in the classroom. Content may be added to the assignment or quiz from materials database 126 (block 812). The teacher may search and browse content from materials database 126 from classroom computer 104, for example, to determine what material may be best for inclusion in the quiz or assignment. The assignment or quiz may be stored (block 814). The teacher may store the assignment or quiz in database 118 along with characteristics associated with the assignment or quiz (such as, e.g., the course name, etc.) as described in more detail above with respect to FIG. 3. For example, a teacher may create the ADVANCED MOLECULAR GEOMETRY QUIZ and save it to database 118 at a location of “c:/home/teacher/mwa.odt”. The teacher may indicate in document table 300 that the quiz is stored in this location and user names in the following groups may access the document: CHEM2 STUDENT, ADMIN, and CHEM2 PARENT. The teacher may indicate in document table 300 that a student may only take the quiz if his or her average in the class is an A or B. Further, the teacher may indicate in document table 300 that a parent may only look at the quiz if the student has already completed the quiz.

Assignments, quizzes, and course profiles may be sent to or associated with students (block 816). In one embodiment, the teacher may use classroom computer 104 to email course profiles, assignments, and/or quizzes to students or associate course profiles, quizzes, or assignments with students' profiles. Teachers may send assignments, quizzes, and course profiles to an entire class, to groups within a class, or to individuals, e.g., individuals in need of special attention.

In one embodiment, a course profile, quiz, or assignment may be associated with a selected or specific achievement level. For example, a difficult math assignment may be associated with students with an “A” average in math. A difficult English course profile may be associated with students in an advanced English class. A remedial science quiz may be associated with students who have a “D” science average. A course profile, quiz, or assignment may also be associated with a class, a group of students, or individual students.

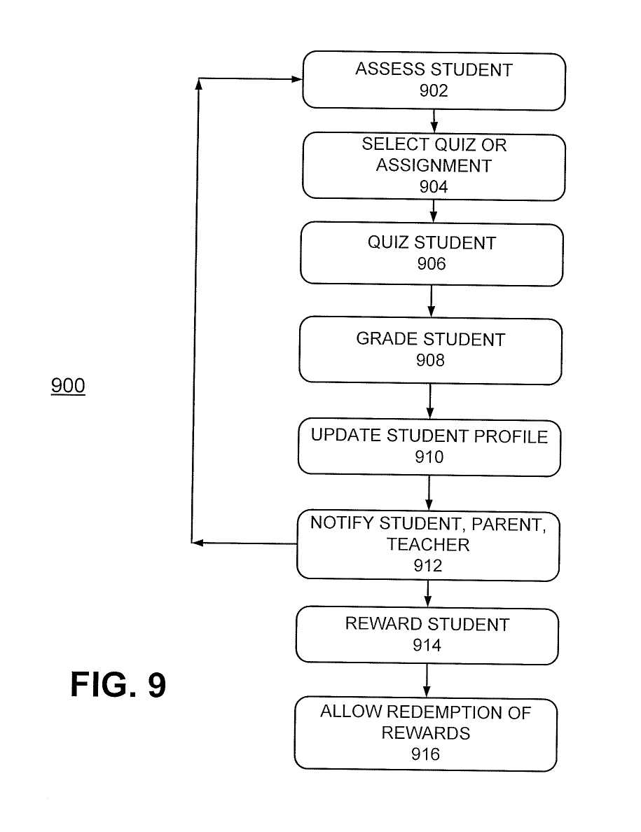

FIG. 9 is a flowchart of an exemplary process 900 for testing students. Process 900 may run in application server 120, for example. In another embodiment, the execution of process 900 may be distributed among various devices in environment 100. Process 900 may begin with a student being assessed (block 902). An assessment may include determining the student's grades for a particular subject. For example, process 900 may access achievement table 500 to determine a student's average in a class. An assessment may include grading an assignment or quiz previously completed by the student. An assessment may include searching document table 300 to determine which assignments, quizzes, or course profiles a particular student satisfies the group requirement (e.g., listed in group field 508) and/or prerequisites (e.g., listed in prerequisites field 310). An assessment may be initiated automatically by interactive environment 100 or may be requested by the student. One of the assignments, quizzes, and/or course profiles found in block 902) may be selected (block 904). The student may select the assignment, quizzes, and/or course profile to complete or interactive environment 100 may select the assignment or quiz automatically.

The student may be quizzed (block 906). Quizzes, assignment, etc., may be retrieved from database 118. The student may be given an assignment or a quiz based on the assessment of the student (e.g., a quiz selected from a group of quizzes base on the assessment). For example, the student may be given a more difficult (or a different) quiz or assignment depending on the student's prior achievement or assessment. For example, a difficult math assignment may be provided to a student with an “A” average in math. A remedial science quiz may be associated with students who have a “D” science average. Process 900 may access information stored in student profile database 124 and/or course curriculum, course profile, and assignment database 118. For example, as discussed above, quizzes, assignment, and course profiles may be associated with different levels of achievement and stored in database 118.

Quizzes and assignments may include different types of media, including PDFs, interactive content, and video. The student may use student computer 104 or TV 110 to download the assignments, quizzes, and other materials. The student may complete the quizzes and assignments on computer 104 or TV 110 and may send the completed quizzes to his or her teacher. In one embodiment, the quizzes and assignments are interactive, online interactive quizzes which are objective and may be scored by the system.

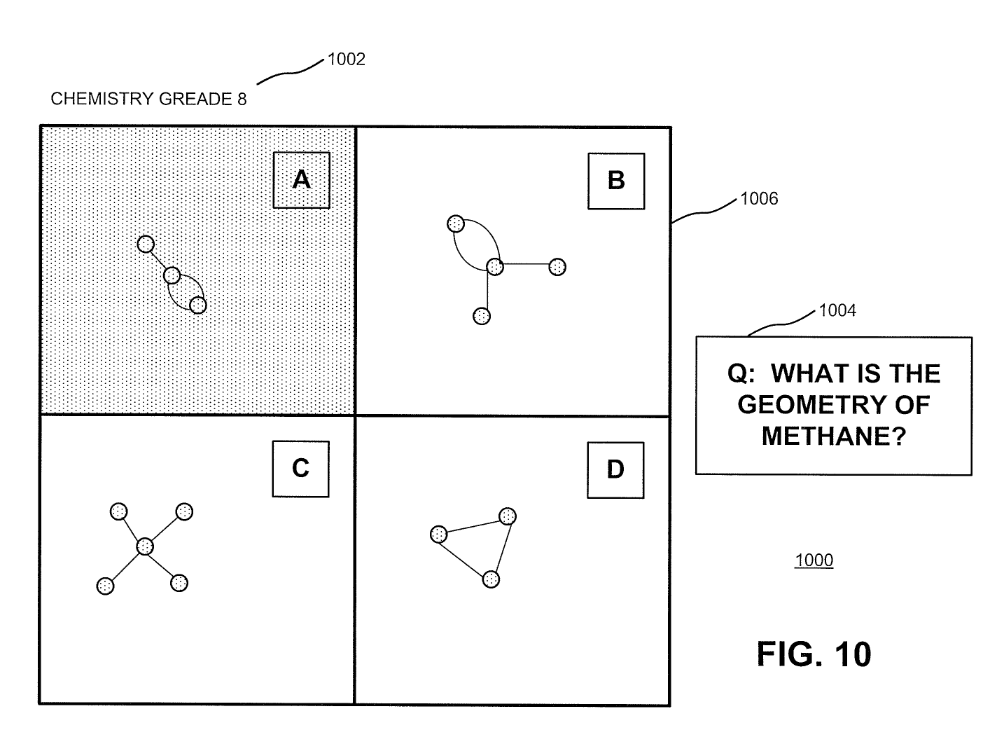

FIG. 10 is a block diagram of an exemplary graphical user interface (GUI) for displaying an exemplary quiz question (GUI 1000). GUI 1000 may include a quiz title 1002, a question 1004, and a multiple choice selection 1006 including A, B, C, and D. The student may use control keys 704 on remote 114 to navigate to what he or she believes to be the correct answer and may select the answer by pressing the OK button. GUI 1000 may be shown on display 706 of remote 114, for example, or on TV 110. A quiz or assignment may include a series of questions, such as the question on exemplary GUI 1000. In one embodiment, the assignment or quiz may be informational in nature, e.g., study material, support information, or support material.

The student may be scored (block 908). For example, the quiz or assignment given to the student in block 906 may be scored, e.g., graded. In one implementation, assignments and quizzes may be scored automatically, which may provide the teacher and parent immediate feedback on student performance. In an embodiment where the assignment or quiz is informational in nature, e.g., study material, support information, or support material, the “scoring” may simply include generating an indication that the student reviewed the material.

The student's profile may be updated (block 910). The student's profile on student profile database 124 may be updated to take into account the score achieved on the test in block 906. For example, if Brandon Lee scored 95% on the ADVANCED MOLECULAR GEOMETRY QUIZ, then achievement table 500 may be updated to include this information (e.g., the information in record 520). Others with access to the student's account (e.g., the student's parents, teacher, principle) may be notified of the updated profile (block 912). For example, John Lee, Brandon's father, may receive an email indicating that Brandon completed the ADVANCED MOLECULAR GEOMETRY QUIZ. John Lee may log into interactive environment 100 and may access student profile database 124. Because, according to privilege table 600, John Lee has access to Brandon Lee's profile, John Lee may see the Brandon's score, e.g., 95%. In one embodiment, students, parents, and teachers can see the progress reports on TV 110, classroom computer 104, or parent computer 108, for example.

As shown in FIG. 9, process 900 may return to block 902 where the student is reassessed. In this embodiment, the student may be reassessed based on the score of the quiz or assignment in block 906. With a new assessment, the student may be retested with a new assignment or quiz in a continual cycle of improvement and learning. In one embodiment, the student may be required to retake the same quiz or assignment before continuing if the student did not achieve a required score.

In addition, the student may be rewarded (block 914) for having completed the quiz or assignment. For example, a student may earn points that may be redeemed for virtual or real merchandise. The number of points earned may be based on the score the student achieved in block 906. The student may be allowed to redeem the awards (block 916). Points may be accumulated by the student over a period of time, for example, and the number of points accumulated by the student may be stored in the student's profile. For example, a student may be able to play a game or watch a movie when a certain number of points have been accumulated. When redeeming points, points may be subtracted from the account associated with the student where the number of points subtracted may be based on a value of merchandise provided to the student.

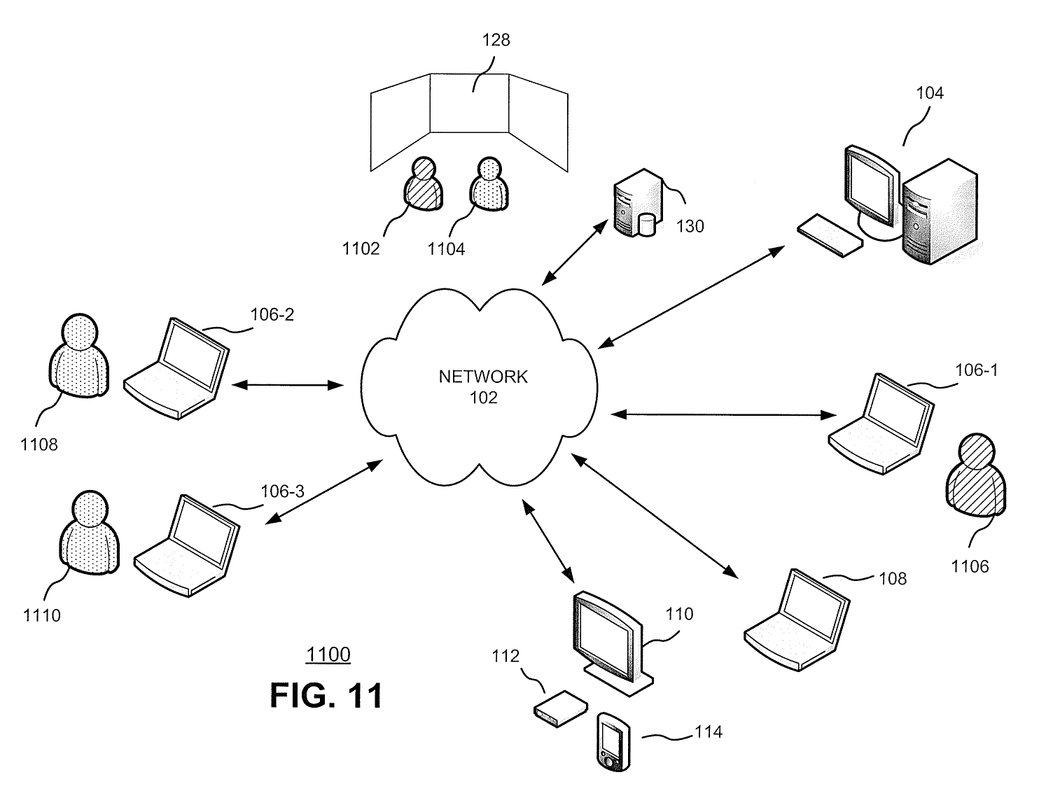

FIG. 11 is a block diagram of an environment 1100 for providing an exemplary interactive quiz show. Environment 1100 may include network 102, studio 128, studio server 130, TV 110, STB 112, remote 114, and student computers 106-1 through 106-3. One or more of student computers 106-1 through 106-3 may be configured similarly to student computer 106 described above. In another embodiment, one or more of student computers 106-1 through 106-3 may be configured similarly to TV 110. In this latter embodiment, one or more of student computers 106-1 through 106-3 may include remote controls and set top boxes similar to remote 114 and STB 118. In this embodiment, quiz questions may be shown on the TV (similar to TV 110) or on the display of the remote control (similar to display 706 of remote 114).

The exemplary interactive quiz show of FIG. 11 may include five students, e.g., contestants: two live students 1102 and 1104 in studio 128 and three students 1106, 1108, and 1110 at student computers 106-1, 106-2, and 106-3, respectively. In one embodiment, students may be associated with different teams. For example, students 1102 and 1106 may attend the same school and may both be associated with a team for the school they both attend. As shown in FIG. 11, students 1102 and 1106 are striped. Contestants 1104, 1108, and 1110 may all attend the same school (but different than contestants 1102 and 1106) and may be associated with a team for the school they attend. As shown in FIG. 11, students 1104, 1108, and 1110 are dotted.

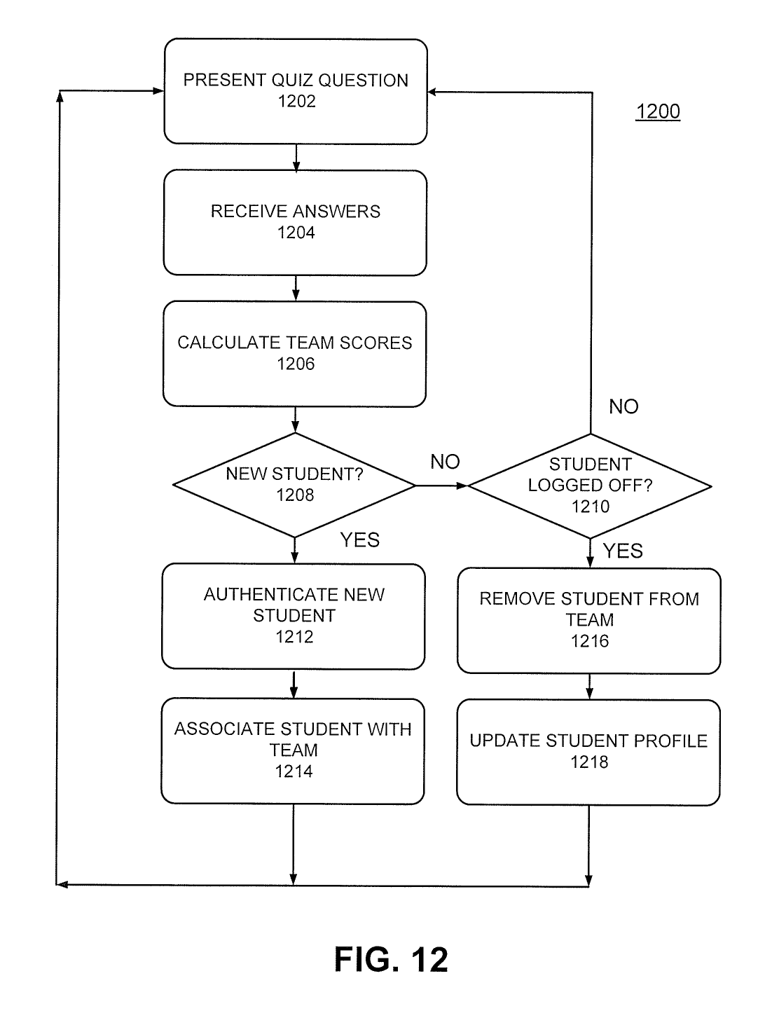

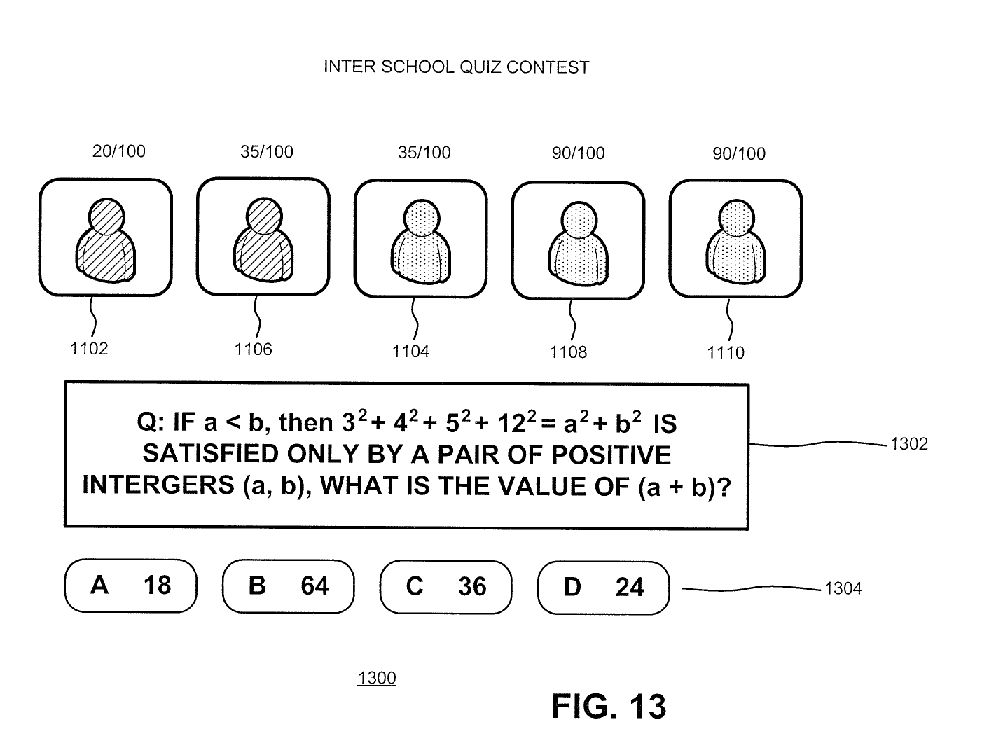

FIG. 12 is a flowchart of an exemplary process 1200 for an interactive quiz game show of FIG. 11. Processing may begin upon presentation of a quiz question to the student contestants (block 1202). FIG. 13 is a block diagram of a GUI 1300 for displaying the exemplary interactive quiz show. GUI 1300 may be shown on TV 110, for example, for viewing by parents, teachers, other students, or the public. GUI 1300 may also be shown on student computers 106-1 through 106-3, for example, for students 1106, 1108, and 1110 to interact with during the live quiz show. GUI 1300 may include pictures or live images of students 1102 through 1110. GUI 1300 may include a question 1302 and multiple choice answers 1304.

Answers may be received (block 1204). For example, student 1106 may use control keys (similar to control keys 704) on a remote control (similar to remote 114) to navigate to what he or she believes to be the correct answer and may select the answer by pressing the OK button. Answers may also be received from students 1108 and 1110 through a keyboard or microphone, for example. The accuracy of the answers and the team score may be determined (block 1206). For example, a contestant may receive a point for every correct answer.

The interactive quiz show may allow for students to join or leave the show. If no new student wishes to join the quiz show (block 1208: NO) and no student logs off the quiz show (block 1210: NO), then process 1200 may return to block 1202 for a new question. If a new student wishes to join the quiz show (block 1208: YES), he or she may be authenticated (block 1212) and associated with a team (block 1214), and process 1200 may then continue with an additional quiz question being presented (block 1202). If a student has logged off (block 1210: YES), then the student may be removed from the appropriate team (block 1216) and the student's profile may be updated (block 1218). Processing may then return to block 1202 for presentation of the next question to the remaining team members or participants.

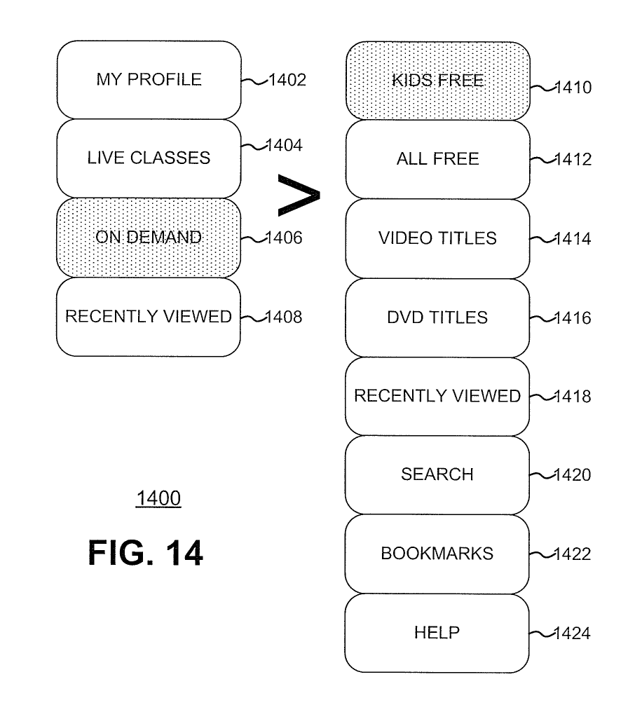

FIG. 14 is a block diagram of a GUI 1400. GUI 1400 may include two columns of buttons, e.g., two columns of menu options. The first column of menu options may include a MY PROFILE option 1402, a LIVE CLASSES option 1404, an ON DEMAND option 1406, and a RECENTLY VIEWED option 1408. In GUI 1400 of FIG. 14, the ON DEMAND option 1406 is highlighted and selected (as shown by the gray shading). The second column of menu options may include a KIDS FREE option 1410, an ALL FREE option 1412, a VIDEO TITLES option 1414, a DVD TITLES option 1416, a RECENTLY VIEWED option 1418, a SEARCH option 1420, a BOOKMARKS option 1422, and a HELP option 1424. This second column of menu options may include the menu options after selecting the ON DEMAND option 1406 from the first column of menu options.

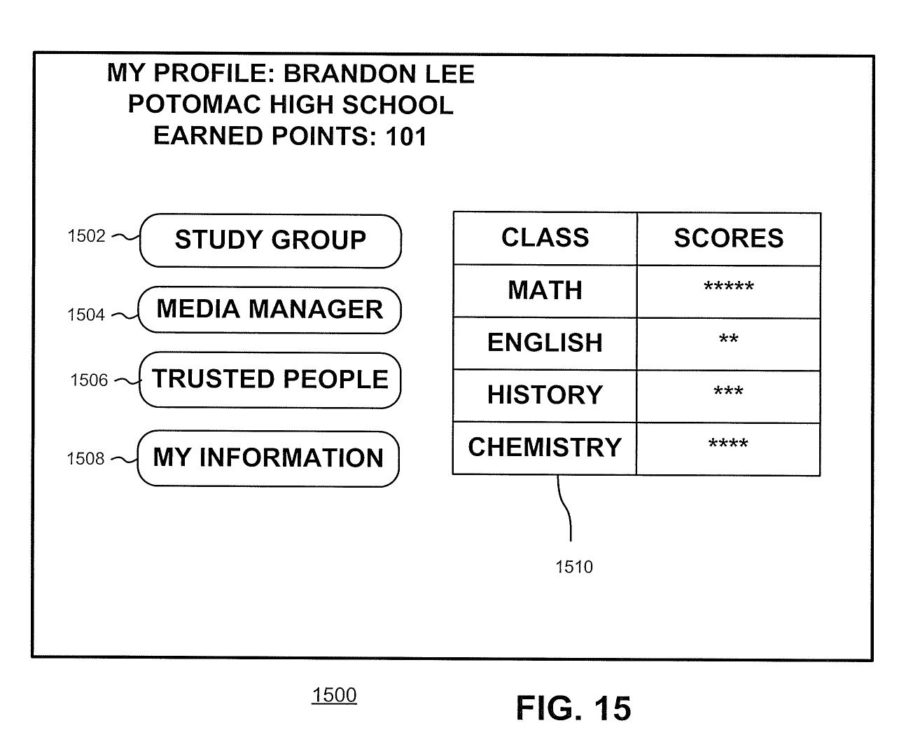

FIG. 15 is a block diagram of a GUI 1500 associated with an exemplary student profile (GUI 1500). As illustrated in FIG. 15, exemplary GUI 1500 may be associated with a student named “Brandon Lee” of “Potomac High School.” GUI 1500 may include a MY INFORMATION option 1502, a STUDY GROUP option 1504, a MEDIA MANAGER option 1504, and a TRUSTED PEOPLE option 1506. A student may select MY INFORMATION option 1502 to access test scores, assignments due, assignment scores, grades, etc. A student may select STUDY GROUP option 1504 to communicate with those and define those other students for interaction. A student may select MEDIA MANAGER option 1506 to view movies, recorded classes, and television shows, and to listen to music, etc. A student may select TRUSTED PEOPLE option 1508 to define individuals that may access the student's information, such as parents, siblings, teachers, and other students. GUI 1500 may also include a brief display 1510 of the student's scores. GUI 1500 may also include the number of points accumulated by the student (for completing assignments and quizzes, for example) for later redemption. As shown in FIG. 15, Brandon Lee has accumulated 101 points for redemption.

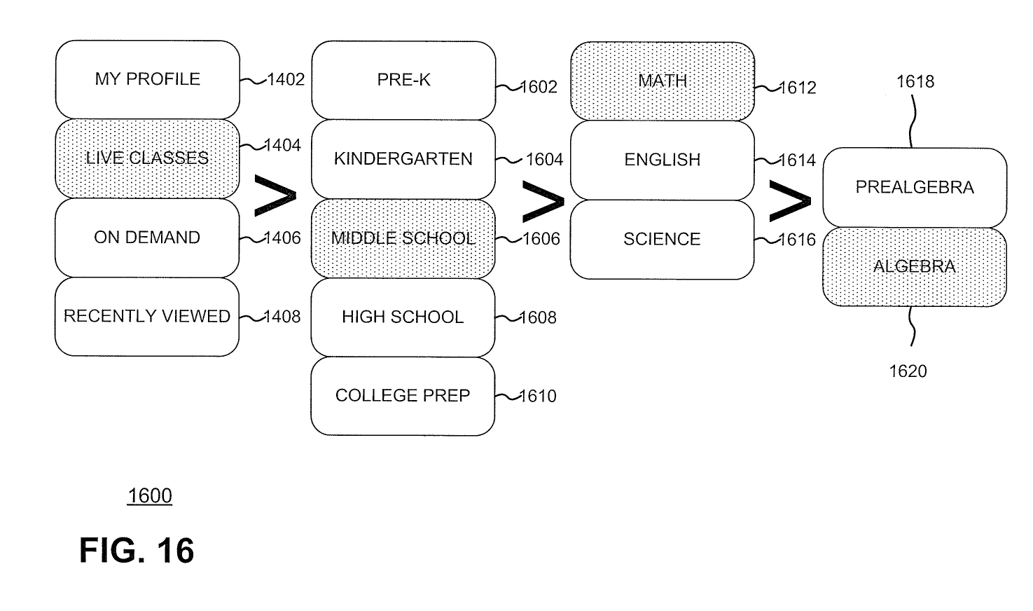

FIG. 16 is a block diagram of another exemplary GUI 1600 associated with selection of an interactive live class. GUI 1600 may include four columns of buttons, e.g., four columns of menu options. Like FIG. 10, the first column of menu options may include a MY PROFILE option 1602, a LIVE CLASSES option 1604, an ON DEMAND option 1606, and a RECENTLY VIEWED option 1608. In GUI 1600 of FIG. 16, the LIVE CLASSES option 1608 is highlighted and selected (as shown by the gray shading). The second column of menu options may include a PRE-K option 1602, KINDERGARTEN option 1604, MIDDLE SCHOOL option 1606, HIGH SCHOOL option 1608, and COLLEGE PREP option 1610. This second column of menu options may include the menu options associated with selecting the LIVE CLASSES option 1604 from the first column of menu options. In the exemplary display in FIG. 16, the MIDDLE SCHOOL option 1606 may be highlighted and selected (as shown by the gray shading). The third column of menu options may include a MATH option 1612, an ENGLISH option 1614, and a SCIENCE option 1616. The third column of menu options may include the menu options associated with selecting the MIDDLE SCHOOL option 1606 in the second column. In exemplary GUI 1600 of FIG. 16, the MATH option 1612 is highlighted and selected (as shown by the gray shading). The fourth column of menu options may include a PRE ALGEBRA option 1618 and an ALGEBRA option 1620. In exemplary GUI 1600 of FIG. 16, ALGEBRA option 1620 may be highlighted and selected (as shown by the gray shading).

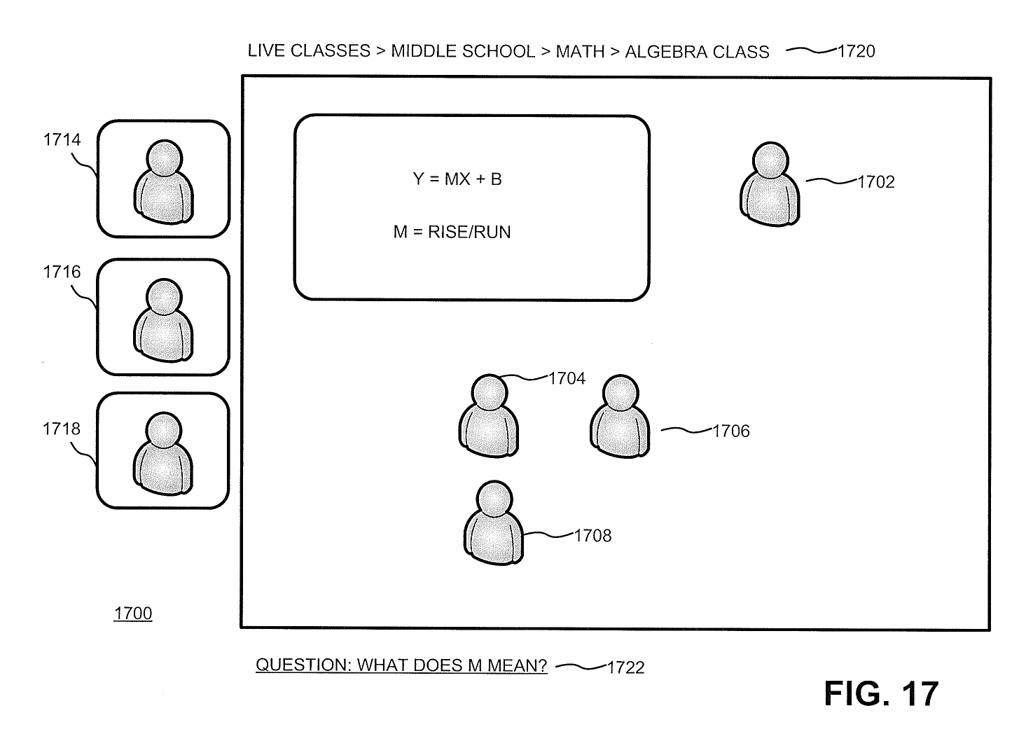

FIG. 17 is a block diagram of an exemplary GUI 1700 associated with providing an interactive live class (GUI 1700). GUI 1700 may include an icon, avatar, image, or live video representing a teacher 1702. GUI 1700 may include icons, avatars, images, or live videos representing students 1704 through 1718. Student icons 1704 through 1708 may be present in the classroom. Student icons 1714 through 1718 may be attending the class remotely via network 102, for example. Teacher 1702 and students 1704, 1706, and 1708 may be able to interact with students 1714, 1716, and 1718 via network 102 (via streaming audio and video) even though they may not be physically present in the classroom. Likewise, students 1714, 1716, and 1718 may be able to interact with teacher 1702 and students 1704, 1706, and 1708 using network 102 (via streaming audio and video) even though they are not physically present in the classroom.

The GUI 1700 includes a title 1720 “LIVE CLASSES>MIDDLE SCHOOL>MATH>ALGEBRA CLASS” that corresponds to the options selected in FIG. 11. As indicated by title 1720, display 1700 may include a live showing of an algebra class, for example. Display 1700 may include a question area 1722 for students to type questions for interactive discussions.

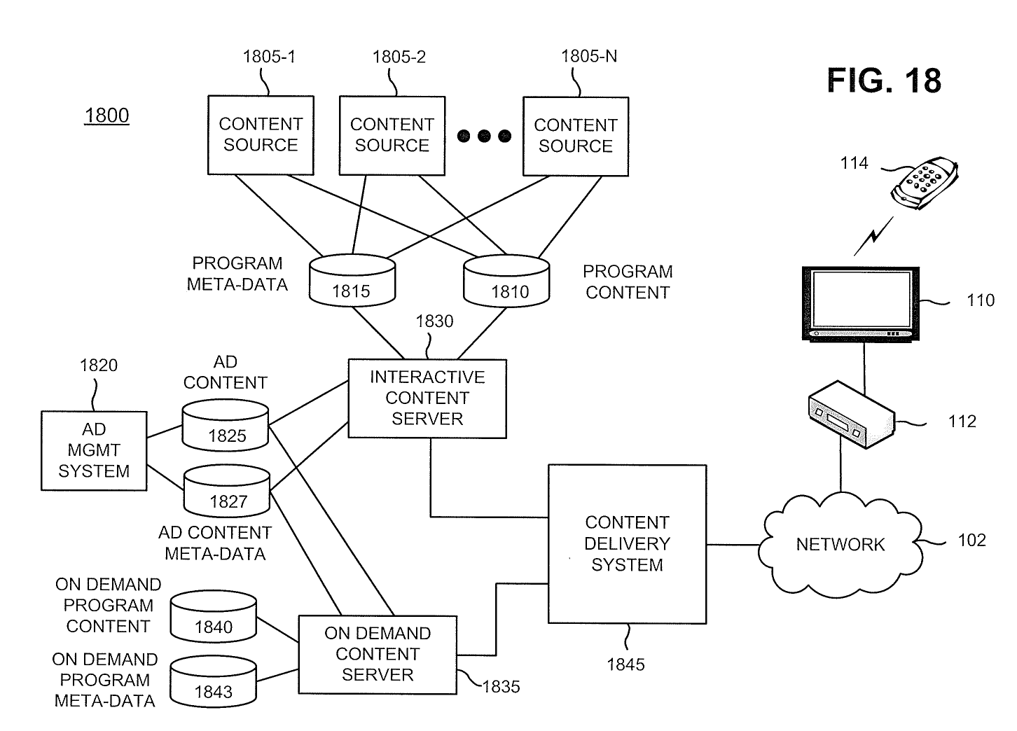

FIG. 18 is a block diagram of an alternative exemplary environment 1800 in which systems and methods described herein may be implemented. Environment 1800 may include content sources 1805-1, 1805-2, . . . , 1805-N (where N>=1) (collectively referred to as “content sources 1805”), a program content database 1810, a program meta-data database 1815, an advertising (ad) management (mgmt) system 1820, an advertising content database 1825, an advertising content meta-data database 1827, an interactive content server 1830, an on-demand content server 1835, an on-demand content database 1840, an on-demand meta-data database 1843, and a content delivery system 1845. Environment 1800 may also include network 102, STB 112, TV 110, and remote control 114 as shown in FIG. 1. In practice, environment 1800 may include more, fewer, or different devices than are shown in FIG. 18. Also, two or more of these devices may be implemented within a single device, or a single device may be implemented as multiple, distributed devices. Further, while FIG. 18 shows direct connections between the various devices, any of these connections can be indirectly made via a network, such as a local area network, a wide area network (e.g., the Internet), a telephone network (e.g., the Public Switched Telephone Network (PSTN) or a cellular network), or a combination of networks.

Content sources 1805 may include any type or form of content, including interactive or non-interactive content. For example, content sources 1805 may include free television broadcasts (e.g., local broadcasts, such as NBC, CBS, ABC, and Fox), for-pay television broadcasts (e.g., TNT, ESPN, HBO, Cinemax, CNN, etc.), and/or web-based content (e.g., streaming content from web sites). Content sources 1805 may also content from environment 100. For example, content sources 1805 may include one or more studios and studio servers, such as studio 128 and studio server 130 of FIG. 1. Content sources 1805 may include one or more materials databases, such as materials database 126 of FIG. 1. Content sources 1805 may include one or more course curriculum, course profile, and assignment databases, such as course curriculum, course profile, and assignment database 118 of FIG. 1. Content sources 1805 may include one or more student profile databases, such as a student profile database 124 of FIG. 1.

Program content database 1810 may store video signals representing the programs provided by various ones of content sources 1805. Program content database 1810 may store interactive or non-interactive content.

Program meta-data database 1815 may store meta-data associated with the programs provided by various ones of content sources 1805. Program meta-data database 1815 may store an association between content and advertisements with which the content corresponds. In one embodiment, program meta-data database 1815 may also store content icons and an association between the content icons and the programs and/or advertisements with which the content icons correspond. The meta-data might include program descriptions, program line-ups and/or schedules, or other information associated with the programs in program content database 1810. An example of meta-data may include information stored in document table 300, e.g., in an XML (eXtensible Markup Language)-based data file.

Advertising management system 1820 may control advertising content presented in connection with the programs in program content database 1810 and/or on-demand content database 1840. Advertising management system 1820 may store advertising content in advertising content database 1825. The advertising content may include advertisements (e.g., commercials that are inserted within a program signal, long form advertisements that are not inserted within the program signal, text or graphics that are overlaid on a program or an advertisement, advertisements that are presented alongside the program signal, and/or interactive advertisements) and/or links to advertisements that may be served via a network, such as the Internet. Advertising content meta-data database 1827 may store meta-data associated with the advertisements in advertising content database 1825. Meta-data stored in database 1827 may include, for example, scheduling information, rating information, category information, length of advertisement, classification information, expiration date of the advertisement, or other information that advertising management system 1820 and/or content servers 1830 and/or 1835 may find useful in serving and/or targeting the advertising content.

Interactive content server 1830 may include a device that is capable of controlling the serving of programs from program content database 1810, the program meta-data from program meta-data database 1815, and/or the advertising content from advertising content database 1825. Interactive content server 1830 may also serve non-interactive content from non-interactive content sources. In one embodiment, content server 1830 may include a content mixing engine to select information, such as programs, program meta-data, advertising content, and/or advertisement meta-data, and mix the information together. Interactive content server 1830 may also perform transcoding of the mixed information. Interactive content server 1830 may include a device that is capable of managing the serving of interactive content, such as live, interactive learning content. Interactive content server 1830 may retrieve content, as necessary, from program content database 1810.

On-demand program database 1840 may store on demand content. For example, previously recorded live, interactive learning content may become on-demand content after a showing and may be stored in on-demand program content database 1840. In one embodiment, on-demand program database 1840 may include one or more materials databases, such as materials database 126 of FIG. 1. On-demand program database 1840 may include one or more course curriculum, course profile, and assignment databases, such as a course curriculum, course profile, and assignment database 118 of FIG. 1. On-demand program database 1840 may include one or more student profile databases, such as a student profile database 124 of FIG. 1.

On-demand meta-data database 1843 may store meta-data associated with the programs stored in on-demand program database 1840. On-demand program meta-data database 1843 may store an association between content and advertisements with which the content corresponds. In one embodiment, on-demand program meta-data database 1843 may also store content icons and an association between the content icons and the programs and/or advertisements with which the content icons correspond. The meta-data might include program descriptions, program line-ups and/or schedules, or other information associated with the programs in on-demand program content database 1840. An example of meta-data may include information stored in document table 300, e.g., in an XML-based data file.

On-demand content server 1835 may retrieve on-demand content, as necessary, from on-demand content database 1840. On-demand content server 1835 may include a device that is capable of controlling the serving of programs from on-demand program content database 1840, meta-data from on-demand meta-data database 1843, meta-data from ad content meta-data database 1827, and/or advertising content from advertising content database 1825. In one embodiment, content server 1830 may include a content mixing engine to select information, such as programs, program meta-data, advertising content, and/or advertisement meta-data, and mix the information together. Content server 1835 may also perform transcoding of the mixed information.

Content delivery system 1845 may include a device that is capable of delivering information to a customer's equipment (e.g., STB 112, TV 110, etc.). Content delivery system 1845 may include a service adapter component and a media relay component. The service adapter component may control what information (e.g., what programs and/or advertisements) to provide to which customers based, for example, on customer subscriptions and/or profiles, groups, etc. (e.g., user table 400, achievement table 500, and/or document table 300). The media relay component may control the transmission of the information to the customers. The media relay component may perform encoding and/or encryption functions. Content delivery system 1845 may also include one or more on demand components that may provide on demand services (e.g., music, video, and/or games on demand).

This patent application hereby incorporates herein by reference the following patent applications, filed on the same day as the present application: (1) INTERACTIVE LEARNING, Attorney Docket No. 20070262; (2) INTERACTIVE LEARNING, Attorney Docket No. 20070263; and (3) INTERACTIVE LEARNING, Attorney Docket No. 20070261.

Interactive learning may be a better learning environment for students as compared to passive television viewing. In one or more embodiments described above, students may communicate and collaborate with their teachers, peers, and parents in a learning environment. One or more embodiments disclosed above may allow for management of the learning work flow; assessment of student achievement; ad hoc communication and collaboration among educators, students, and parents; and sharing and management of educational content. A high-speed, symmetric, fiber-optic network may provide for some or all of the structure to implement systems and methods described herein.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

While series of blocks have been described above, such as in FIGS. 8, 9, and 12, the order of the blocks may differ in other implementations. Moreover, non-dependent acts may be performed in parallel.

It will be apparent that aspects of the embodiments, as described above, may be implemented in many different forms of software, firmware, and hardware in the implementations illustrated in the figures. The actual software code or specialized control hardware used to implement these embodiments is not limiting of the invention. Thus, the operation and behavior of the embodiments of the invention were described without reference to the specific software code—it being understood that software and control hardware may be designed to implement the embodiments based on the description herein.

Further, certain portions of the invention may be implemented as “logic” that performs one or more functions. This logic may include hardware, such as an application specific integrated circuit, a field programmable gate array, a processor, or a microprocessor, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method comprising:
identifying, by a computer, scores and class names stored in a database and associated with a student;
selecting, by a computer, a quiz or assignment from a plurality of quizzes based on the identification of the scores and class names;
sending the selected quiz or assignment through a network to the student;
receiving, through the network, a completed quiz or assignment from the student; and
scoring, by the computer, the completed quiz or assignment and recording a score associated with the completed quiz or assignment in the database.

2. The method of claim 1, further comprising:
adding a first number of points to an account associated with the student, the first number of points based on the score associated with the completed quiz or assignment;
receiving a request from the student for merchandise; and
subtracting a second number of points from the account associated with the student, the second number of points subtracted based on a value of the merchandise.

3. The method of claim 1, further comprising:
associating each of the plurality of quizzes or assignments with one of a plurality of achievement levels, and where selecting the quiz or assignment from the plurality of quizzes or assignments includes comparing the identified scores with the plurality of achievement levels.

4. The method of claim 3, further comprising:
associating each of the plurality of quizzes or assignments with one of a plurality of academic class names, and where selecting the quiz or assignment from the plurality of quizzes or assignments includes comparing the identified class names with the plurality of academic class names.

5. The method of claim 1, further comprising:
sending, through the network, a notification to a parent of the student of the completed quiz or assignment.

6. The method of claim 5, where the database includes information indicative of user names allowed to access the scores stored in the database associated with the student, the method further comprising:
comparing a user name associated with the parent of the student with the information indicative of user names allowed to access the scores stored in the database associated with the student.

7. The method of claim 1, further comprising:
displaying the quiz or assignment on a display.

8. The method of claim 7, further comprising:
receiving answers to the quiz or assignment in a remote control associated with the display.

9. A system comprising:
a database to store:
scores associated with a student and student class names associated with the student; and
a plurality of quizzes or assignments, a plurality of achievement levels, and a plurality of quiz or assignment class names, wherein one of the plurality of achievement levels and one of the plurality of quiz or assignment class names is associated with each of the plurality of quizzes or assignments;
a processor to:
analyze the scores and student class names associated with the student; and
select one of the plurality of quizzes or assignments based on the analysis of the scores and student class names associated with the student, the plurality of achievement levels, and the plurality of quiz or assignment class names; and
a transceiver to send the selected one of the plurality of quizzes or assignments to the student through a network and receive, through the network, a completed quiz or assignment from the student;
where the processor is further configured to score the completed quiz or assignment, record a score associated with the completed quiz or assignment in the database, and associate the score associated with the completed quiz or assignment with the student.

10. The system of claim 9, where the processor is further configured to add a first number points to an account associated with the student, the first number of points based on the score associated with the completed quiz or assignment.

11. The system of claim 10, where the processor is further configured to subtract a second number of points from the account associated with the student, the second number of points subtracted based on a value of merchandise provided to the student.

12. The system of claim 9, further comprising:
a remote control including a display for displaying the quiz or assignment.

13. The system of claim 12, where the remote control is configured to receive answers to the quiz or assignment.

14. The system of claim 9, where the transceiver is further configured to send a notification of the score associated with the completed quiz or assignment to a parent of the student.

15. A computer-readable medium including instructions executable by at least one processor, the computer-readable medium comprising:
one or more instructions for analyzing scores stored in a database and associated with a student;
one or more instructions for selecting a quiz or assignment from a plurality of quizzes or assignments based on the analysis of the scores and sending the selected quiz or assignment through a network to the student;
one or more instructions for receiving, through the network, a completed quiz or assignment from the student;
one or more instructions for scoring the completed quiz or assignment and recording a score associated with the completed quiz or assignment in the database; and
one or more instructions for adding a number of points to an account associated with the student, the number of added points based on the score associated with the completed quiz or assignment.

16. The computer-readable medium of claim 15, further comprising:
one or more instructions for associating the plurality of quizzes or assignments with a plurality of achievement levels.

17. The computer-readable medium of claim 15, where the one or more instructions for selecting the quiz or assignment from the plurality of quizzes or assignments includes one or more instructions for comparing the analysis of the scores with the plurality of achievement levels.

18. The computer-readable medium of claim 15, further comprising:
one or more instructions for sending, through the network, a notification to a parent of the student of the score associated with the completed quiz or assignment.

19. The method of claim 15, further comprising:
one or more instructions for displaying the quiz or assignment on a display associated with a remote control.

20. The method of claim 19, further comprising:
one or more instructions for receiving answers to the quiz or assignment in the remote control.

21. An apparatus comprising:
means for identifying scores stored in a database and associated with a student;
means for selecting a quiz or assignment from a plurality of quizzes or assignments based on the identified scores;
means for sending the quiz or assignment to the student;
means for receiving a completed quiz or assignment from the student;
means for scoring the completed quiz or assignment and recording a score associated with the completed quiz or assignment in the database;
means for adding a first number of points to an account associated with the student, the first number of points based on the score associated with the completed quiz or assignment; and
means for subtracting a second number of points from the account associated with the student, the second number of points subtracted based on a value of merchandise provided to the student.

22. The apparatus of claim 21, further comprising:
means for electronically notifying a parent of the student of the score associated with the completed quiz or assignment.

23. The method of claim 21, further comprising:
means for displaying the quiz or assignment on a display.

24. The method of claim 23, further comprising:
means for receiving answers to the quiz or assignment in a remote control associated with the display.
